(19) United States
(12) Patent Application Publication
(10) Pub. No.: US 2026/0087494 A1
(43) Pub. Date: Mar. 26, 2026

(54) System and Method for Dynamic Subscription Management Using Artificial Intelligence

(71) Applicants: ZONGXIANG ZHANG, Sunny Isles Beach, FL (US); Cody Altizer, Sunny Isles Beach, FL (US)

(72) Inventors: ZONGXIANG ZHANG, Sunny Isles Beach, FL (US); Cody Altizer, Sunny Isles Beach, FL (US)

(21) Appl. No.: 18/892,429

(22) Filed: Sep. 22, 2024

(51) Int. Cl. G06Q 20/40

(52) U.S. Cl. CPC G06Q 20/4016

(57) ABSTRACT

The present invention discloses a dynamic subscription management system and method utilizing artificial intelligence. The system comprises a computing device configured to preauthorize a customer's payment instrument, forecast potential chargebacks using machine learning, estimate future cash flow, detect fraudulent activity using AI models, and dynamically adjust subscription terms based on customer characteristics. The computing device generates user interfaces displaying analytics and recommendations, and can automatically implement optimizations. The method includes acquiring real-time transaction data, analyzing attributes using machine learning to predict optimal payment processors, routing transactions accordingly, and dynamically adjusting subscriptions based on AI analysis of customer behavior. The system and method aim to prevent fraud, reduce chargebacks, optimize payment routing, and improve customer retention.

### BACKGROUND OF THE INVENTION

### Field of Invention

The present invention relates to the field of subscription management systems.

### Description of Prior Art

Subscription-based pricing models are widely used for products and services. However, problems exist with current subscription management systems. Existing systems struggle to effectively prevent fraud, predict and manage chargebacks, optimize cash flow, and dynamically adjust subscription terms based on customer behavior to reduce financial risk, maximize customer lifetime value, and reduce churn.

Some systems analyze historic chargeback data to project future chargebacks. However, very few systems proactively predict if a specific customer will initiate a chargeback on their subscription. Furthermore, existing systems do not leverage real-time data to make preemptive adjustments to subscription terms to maximize retention and reduce churn.

Accordingly, there is a need in the art for an improved subscription management system that proactively prevents fraud and chargebacks, optimizes payment routing, and dynamically adjusts subscription terms using AI-driven insights from real-time customer data—enabling capabilities critical for success in the modern subscription economy.

### BRIEF SUMMARY OF THE INVENTION

This summary is provided to introduce a selection of concepts, in a simplified format, that are further described in the detailed description of the invention. This summary is neither intended to identify key or essential inventive concepts of the invention nor is it intended for determining the scope of the invention.

The present invention provides a dynamic subscription management system that leverages artificial intelligence and machine learning to optimize subscription operations, enhance customer retention, and mitigate financial risks, including fraudulent chargebacks as well as chargebacks resulting from customer dissatisfaction. The system comprises a computing device configured to preauthorize a customer's payment instrument for a predetermined period before initiating a subscription, thus reducing chargeback risk.

In one embodiment, the computing device acquires historical sales and chargeback data along with current customer purchasing behavior and demographics to forecast potential chargebacks using a machine learning model. For example, the model may predict that a customer from a specific zip code purchasing a cart value under $50 is likely to chargeback on a $30/month subscription but not a $10/month subscription. This enables the system to estimate future cash flows and payouts net of deductibles based on individual account characteristics. A user interface displays these predictive insights, empowering subscription service providers with data-driven decision making capabilities.

The invention further includes an artificial intelligence model that detects deviations in new merchant performance compared to historical data, identifying potential fraudulent activities and transmitting alerts to clients. Advantageously, this proactive fraud detection functionality minimizes financial losses associated with fraudulent transactions.

A key aspect of the invention involves dynamically adjusting subscription terms, billing cycles, and pricing based on an AI-driven analysis of customer characteristics and behaviour. By intelligently adapting to individual customer patterns, the system optimizes subscriber retention while ensuring compliance with subscription terms. This feature addresses a significant challenge in the subscription industry, reducing churn rates and enhancing customer lifetime value.

The invention further improves upon prior art through intelligent payment routing based on AI detection of the consumer card brand. The system routes transactions to the merchant account preferred by each card brand to maximize approval ratios.

In operation, the dynamic subscription management system of the present invention mitigates the problems of fraudulent and dissatisfaction-based chargebacks, suboptimal approval ratios, and customer churn that are prevalent in existing subscription management solutions. By leveraging AI and machine learning to tailor subscription terms to individual customers and intelligently route payments, the invention improves retention, optimizes cash flows, and reduces financial risks for subscription service providers.

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a system block diagram illustrating the components and interactions of a dynamic subscription management system.

FIG. 2 illustrates a user interface diagram depicting the components and interactions of a dynamic subscription management dashboard, according to one embodiment.

FIG. 3 is a flow diagram illustrating the process of a user interacting with the dynamic subscription management system via the user interface dashboard, according to one embodiment.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

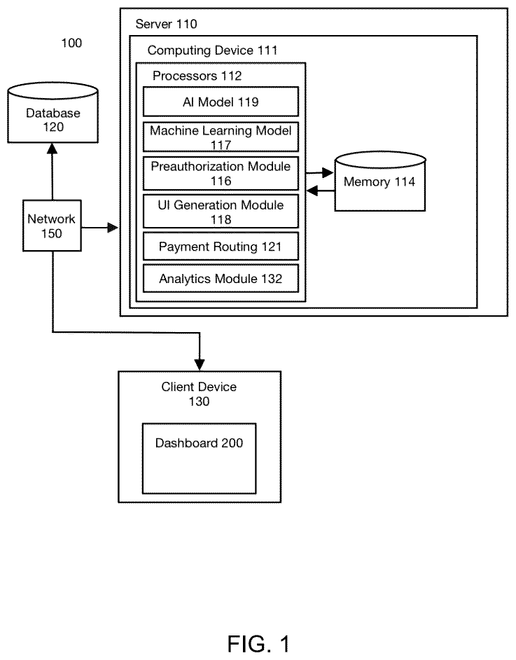

FIG. 1 is an embodiment of a system block diagram illustrating the components and interactions of a dynamic subscription management system 100. In the illustrated embodiment, the system 100 includes a computing device 111 with one or more processors 112 and a memory 114 hosted on a server 110. The server 110 is communicatively coupled to a database 120, a client device 130, via a network 150, wherein the network 150 may be the Internet, a local area network (LAN), a wide area network (WAN), or any other suitable wired or wireless communication network.

According to one embodiment, the computing device 111 is configured to preauthorize a customer's payment instrument, such as a credit card, debit card, or bank account, for a predetermined time period before initiating a subscription. The preauthorization module 116, which may be implemented as a software component executed by the processor(s) 112, authorizes the payment instrument for a period of 48 hours prior to subscription initiation. In some embodiments, based on data such as zipcode indicating a higher likelihood or lower likelihood of chargebacks, this time period can be shortened e.g. to 24 hours or lengthened to 72 hours.

In the illustrated embodiment, the computing device 111 acquires historical sales data and chargeback data from the database 120, wherein the database 120 may be a relational database, a NoSQL database, or any other suitable type of database. A machine learning model 117, such as a neural network, decision tree, or support vector machine, is trained on the historical data and used to forecast potential chargebacks and estimate future new sales. Optionally, the machine learning model 117 may be implemented using popular frameworks such as TensorFlow, PyTorch, or scikit-learn. The computing device 111 also estimates future cash flow and payouts net of deductibles based on historical account performance data retrieved from the database 120, using statistical modeling techniques such as time series analysis or regression analysis.

A user interface generation module 118 creates a user interface with a dashboard 200 displaying the chargeback forecast, cash flow estimate, and other relevant metrics, wherein the user interface is transmitted to the client device 130 for viewing by a user. In one embodiment, the client device 130 may be a personal computer, laptop, tablet, smartphone, or any other computing device with a display and input capabilities. The user interface may be a web-based interface accessible through a web browser, or a native mobile application interface. The dashboard 200 also provides controls for subscription management, such as modifying subscription terms, upgrading or downgrading plans, and canceling subscriptions. Additionally, the user interface displays real-time notifications and alerts related to potential fraudulent activity, payment failures, or other critical events.

In the illustrated embodiment, the computing device 111 employs an artificial intelligence model 119, such as a deep learning model or a reinforcement learning model, to detect deviations in new merchant performance data compared to historical merchant performance data stored in the database 120. Deviations may include, but are not limited to, an increase in chargeback rates above a first predetermined threshold (e.g., 1%), a decrease in sales volume below a second predetermined threshold (e.g., 20%), or an increase in refund requests above a third predetermined threshold (e.g., 5%). If potential fraudulent activity is identified based on these deviations, the computing device 111 transmits a fraud alert to the client device 130, wherein the client device 130 may be a point-of-sale (POS) system, a merchant's computer or mobile device, or any other suitable computing device. The artificial intelligence model 119 assesses the likelihood of chargebacks before transactions are finalized, allowing the system to dynamically adjust pre-authorization periods and implement other risk mitigation measures.

The artificial intelligence (AI) model 119 also analyzes customer characteristics and behavior data, such as demographics, purchase history, and engagement metrics, to dynamically adjust a customer's subscription terms, thereby aiming to optimize customer retention while complying with the subscription terms. By way of example and not limitation, the model may recommend extending a customer's trial period, offering a discount, or upgrading their subscription tier based on their usage patterns and likelihood of churn. In one embodiment, these recommended adjustments to subscription terms, billing cycles, or pricing are automatically implemented by the computing device 111, and notifications of the adjustments are sent to the client device 130.

According to one embodiment, the computing device 111 segments customers into categories based on the AI analysis, using clustering algorithms such as k-means or hierarchical clustering, and applies differentiated subscription management rules to each category. The AI model analyzes customer behavior, such as purchase frequency, average order value, product preferences, and engagement with marketing communications, to identify patterns and segment customers into distinct groups. Based on these segments, the system dynamically assigns customers to the most appropriate subscription plans, ensuring that each customer receives a tailored experience that aligns with their needs and preferences. For instance, high-value customers may be offered more flexible subscription terms or exclusive perks, while customers at high risk of churn may be targeted with retention campaigns.

In one embodiment, the AI model 119 features a training and feedback loop module that continuously improves the AI-driven components. As new data is collected and processed, the module retrains the AI models using techniques such as online learning and transfer learning. The refined models are then deployed to production, ensuring that the system adapts to changing patterns and delivers up-to-date predictions and recommendations.

An intelligent payment routing system 121 selects an optimal merchant account for each transaction based on AI detection of the consumer card brand. The system 121 routes transactions to the merchant account preferred by each card brand to maximize approval ratios.

In one embodiment, when a transaction is initiated, the intelligent payment routing system 121 analyzes the customer's characteristics (e.g., location, transaction amount, payment method) and the real-time performance data of the integrated payment processors. The system 121 then applies a set of predefined rules and machine learning algorithms to determine the optimal processor for that specific transaction. For example, if a customer is located in a country where a particular processor has higher approval rates, the system 121 may route the transaction to that processor. Similarly, if a processor offers lower fees for transactions above a certain amount, the system 121 may choose that processor for high-value transactions.

Additional features of the system 100 include, but are not limited to: providing real-time analytics on customer subscription data, such as subscriber growth rates, churn rates, and lifetime value, via user interfaces transmitted to the client device 130; dynamically reducing subscription fees by predetermined amounts for set time periods; and pre-emptively lowering a customer's subscription value on a recurring basis, in compliance with the subscription terms, to mitigate cancellations or chargebacks. The subscription management and billing module of the system manages the entire subscription lifecycle, including but not limited to billing, renewals, upgrades, downgrades, and cancellations.

The data analytics and reporting module 132 collects and analyzes data from various system components, such as customer interactions, transaction records, and subscription metrics. This data is used to generate actionable insights and key performance indicators (KPIs) that enable merchants to monitor the effectiveness of their subscription strategies.

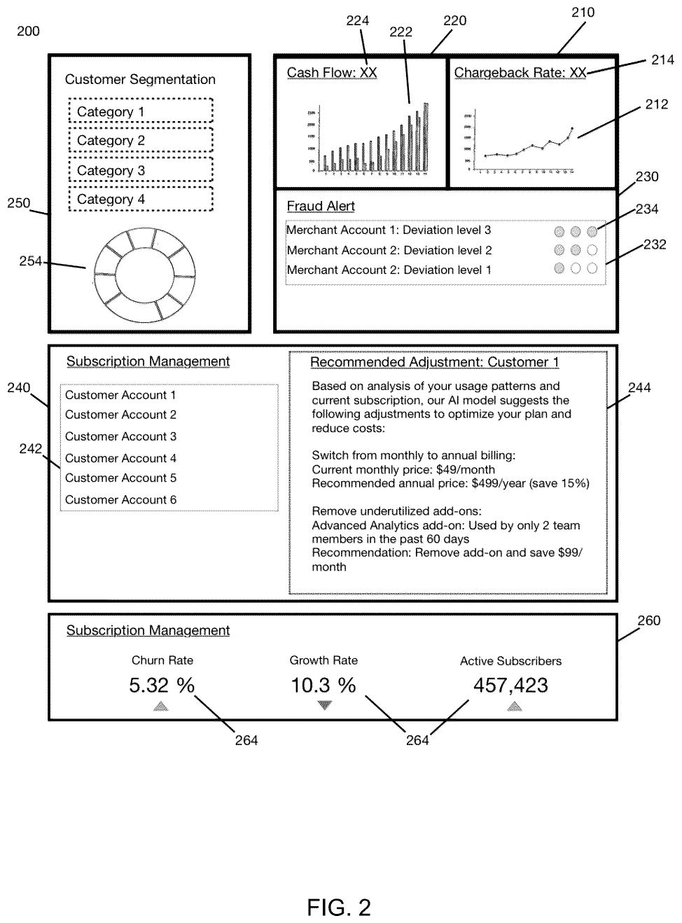

FIG. 2 illustrates a user interface diagram depicting the components and interactions of a dynamic subscription management dashboard 200, according to one embodiment. The dashboard 200 is generated by the user interface generation module 118 and displayed on the client device 130.

In the illustrated embodiment, the dashboard 200 comprises a chargeback forecast section 210 that visually presents the potential chargeback forecast data generated by the machine learning model 117. The chargeback forecast section 210 includes a graphical representation 212 of the forecasted chargeback rate over time and a numerical display 214 of the current forecasted chargeback rate.

Additionally, a cash flow estimate section 220 is configured to display the estimated future cash flow and payouts net of deductibles based on historical account performance data. The cash flow estimate section 220 includes a graphical representation 222 of the estimated cash flow over time and a numerical display 224 of the current estimated cash flow.

Furthermore, the dashboard 200 includes a fraud alert section 230, wherein the fraud alert section 230 is configured to display any potential fraudulent activity detected by the artificial intelligence model 119. The fraud alert section 230 comprises a list 232 of merchant accounts with detected deviations and a severity indicator 234 for each listed account, indicating the level of potential fraud risk.

In one embodiment, a subscription management section 240 is disposed on the dashboard 200, wherein the subscription management section 240 is configured to display recommended adjustments to subscription terms, billing cycles, or pricing generated by the artificial intelligence model 119. The subscription management section 240 includes a list 242 of customer accounts with recommended adjustments and a summary 244 of the recommended changes for each listed account.

Moreover, the dashboard 200 provides a customer segmentation section 250 that displays the customer categories determined by the AI analysis. The customer segmentation section 250 includes a list 252 of customer categories and a graphical representation 254 of the distribution of customers across the categories.

Additionally, a real-time analytics section 260 is configured to present real-time data on customer subscriptions, such as subscriber growth rates, churn rates, and lifetime value. The real-time analytics section 260 includes subscription metrics over time and numerical displays 264 of the current values for each metric.

In one embodiment, the dashboard 200 includes a module configuration section (not shown), wherein the user can enable or disable different modules, such as the Dynamic Pre Authorization module, Payment Routing module, and Customer Segmentation and Dynamic Subscription Management module. According to this embodiment, the user can select which modules to activate based on their specific business requirements and preferences. Once the desired modules are enabled, the system 100 utilizes real-time consumer data and learnings from across all clients, thereby performing the functions of the selected modules.

In another embodiment, the dashboard 200 provides an adjustment interface (not shown) that is configured to enable the user to make manual modifications to the system's recommendations and settings. In this embodiment, the user can fine-tune parameters, such as the target customer retention rate, maximum allowable chargeback rate, and other relevant variables. Alternatively, this interface allows the user to provide feedback on the accuracy of the system's fraud detection, thereby helping to improve the performance of the machine learning model 117 and artificial intelligence model 119 over time. The user's inputs and adjustments are processed by the computing device 111, which is configured to update the AI models accordingly and dynamically adjust customer subscription terms, billing cycles, and pricing based on the revised recommendations.

In the illustrated embodiment, the user interacts with the dashboard 200 by selecting various sections to view more detailed information or to input parameters for the AI models. By way of example and not limitation, the user may click on a specific merchant account in the fraud alert section 230 to view more details about the detected deviations and to provide feedback on whether the activity is actually fraudulent. Optionally, the user may also adjust settings for the subscription management section 240, such as specifying the target customer retention rate or the maximum allowable chargeback rate.

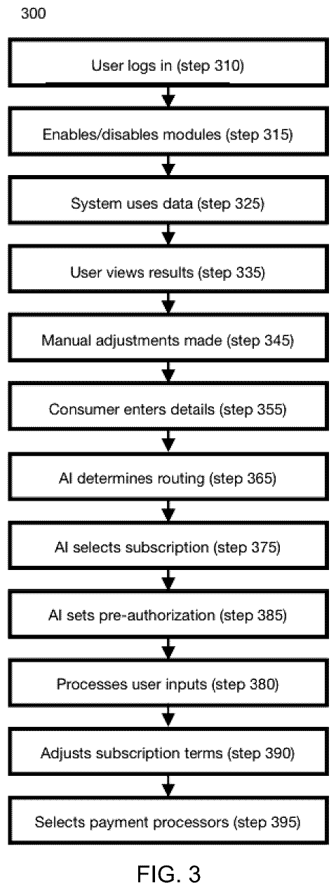

FIG. 3 is a flow diagram illustrating the process 300 of a user interacting with the dynamic subscription management system 100 via the user interface dashboard 200, according to one embodiment.

In the illustrated embodiment shown in FIG. 3, the process begins with the user logging into the system 100 via a client device 130 and accessing the dynamic subscription management dashboard 200 generated by the user interface generation module 118 of the computing device 111 (step 310).

The user then enables or disables different modules, such as the Dynamic Pre Authorization module, Payment Routing module, and Customer Segmentation and Dynamic Subscription Management module (step 315).

The system 100 now uses real-time consumer data and learnings from across all clients to perform the functions of the enabled modules (step 325). In one embodiment, this data is retrieved from the database 120 and processed by the machine learning model 117 and artificial intelligence model 119.

The user views the results of the enabled modules, including the chargeback forecast data in the chargeback forecast section 210, the estimated future cash flow and payouts in the cash flow estimate section 220, any potential fraudulent activity in the fraud alert section 230, recommended adjustments to subscription terms, billing cycles, or pricing in the subscription management section 240, customer segmentation data in the customer segmentation section 250, and real-time analytics on customer subscription metrics in the real-time analytics section 260 (step 335).

The user can make manual adjustments, enable or disable modules as needed, and set their own rules via input controls on the client device 130 (step 345). In this configuration, the user provides feedback on whether detected activity is genuinely fraudulent and may modify settings, such as the target customer retention rate or maximum allowable chargeback rate.

If the process 300 is being performed from the perspective of a consumer (the client's customer), it would work as follows:

The consumer enters their card details to purchase a product via the client device 130 (step 355).

The AI Engine, consisting of the machine learning model 117 and artificial intelligence model 119, leverages the consumer's demographics, purchasing behaviors, and the entire database 120 to determine:
A. Which merchant account to route their payment to (step 365)
B. Which subscription to show them and enroll them in (step 375)
C. The pre-authorization window that's used when their subscription hits (step 385)

The computing device 111 processes the user's inputs and adjustments from the client device 130 (step 380). In the illustrated embodiment, it updates the machine learning model 117 and artificial intelligence model 119 based on the user's feedback and settings changes.

In one embodiment, the computing device 111 dynamically adjusts customer subscription terms, billing cycles, and pricing based on the AI model 119's recommendations and the user's input (step 390). It sends notifications of the adjustments to the client device 130 via the network 150.

The intelligent payment routing system 121 of the computing device 111 selects optimal payment processors for each subscription transaction based on real-time analysis of processor performance data retrieved from the database 120 (step 395). In the illustrated embodiment, the computing device 111 routes the transactions accordingly to optimize approval rates.

Throughout this process, the system 100 leverages the preauthorization module 116 to authorize customer payment instruments for a predetermined time period before initiating subscriptions. In one embodiment, the system 100 continuously updates its forecasts, estimates, and recommendations based on the latest data and user feedback, thereby enabling dynamic, AI-driven optimization of the subscription management process.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. system for dynamic subscription management, comprising:
a. a computing device including one or more processors and a memory, the computing device configured to:
i. preauthorize a customer's payment instrument for a predetermined time period before initiating a subscription;
ii. acquire historical sales data and chargeback data from a database;
iii. forecast, using a machine learning model, potential chargebacks based on the historical data and estimates of future new sales;
iv. estimate future cash flow and payouts net of deductibles based on historical account performance data;
v. generate a user interface displaying the chargeback forecast and cash flow estimate;
vi. detect, using an artificial intelligence model, deviations in new merchant performance data compared to historical merchant performance data to identify potential fraudulent activity; and
vii. transmit a fraud alert to a client device when potential fraudulent activity is identified;
b. wherein the computing device is further configured to dynamically adjust, based on an artificial intelligence driven analysis of customer characteristics, a customer's subscription terms to optimize customer retention while complying with the subscription terms.

2. The system of claim 1, wherein preauthorizing the customer's payment instrument comprises authorizing the payment instrument for a period of hours which depends on the customer's zip code before initiating the subscription.

3. The system of claim 1, wherein the machine learning model used to forecast potential chargebacks is trained on the historical sales data and chargeback data acquired from the database.

4. The system of claim 1, wherein the computing device is further configured to: analyze, using the artificial intelligence model, customer characteristics and behavior data; and generate recommendations for dynamically adjusting subscription terms, billing cycles, or pricing to optimize customer retention.

5. The system of claim 4, wherein the computing device is further configured to: automatically implement the recommendations for dynamically adjusting the subscription terms, billing cycles, or pricing; and transmit notifications of the adjustments to a merchant device and a customer device.

6. The system of claim 1, wherein detecting deviations in new merchant performance data comprises identifying one or more of: an increase in chargeback rates above a first predetermined threshold; a decrease in sales volume below a second predetermined threshold; or an increase in refund requests above a third predetermined threshold.

7. The system of claim 1, wherein the computing device is further configured to: segment customers into a plurality of categories based on an analysis of the customer characteristics using the artificial intelligence model; and apply different subscription management rules to each category of customers.

8. The system of claim 1, wherein the computing device is further configured to: select, using an intelligent payment routing system, a payment processor for each transaction based on a real-time analysis of processor performance data; and route each transaction to the selected payment processor to optimize transaction approval rates.

9. The system of claim 1, wherein dynamically adjusting the customer's subscription terms comprises reducing a subscription fee by a predetermined amount for a predetermined time period.

10. The system of claim 1, wherein the computing device is further configured to: generate a user interface displaying real-time analytics related to customer subscription data, including subscriber growth rates, churn rates, and lifetime customer value; and transmit the user interface to a merchant device.

11. A computer-implemented method for optimizing subscription transaction approvals, comprising:
a. establishing, by a computing device including one or more processors, a data connection with a payment processing network;
b. acquiring, via the data connection, real-time transaction data associated with a subscription;
c. extracting, by the computing device, transaction attributes from the real-time transaction data;
d. analyzing the extracted transaction attributes using a machine learning model trained on historical transaction data;
e. generating, based on the machine learning analysis, a predicted optimal payment processor for the subscription transaction;
f. routing, by the computing device, the subscription transaction to the predicted optimal payment processor;
g. dynamically adjusting, based on an artificial intelligence driven analysis of customer behavior and usage patterns, the subscription's terms, billing cycle, and pricing;
h. generating a user interface displaying recommendations for subscription optimization; and
i. automatically implementing, in response to receiving user confirmation via the user interface, the recommended changes to the subscription.

12. The computer-implemented method of claim 1, further comprising: pre-authorizing, by the computing device, a customer's payment method for a predetermined time period before initiating the subscription.

13. The computer-implemented method of claim 1, further comprising: forecasting, using the machine learning model trained on historical sales data and chargeback data, potential chargebacks based on estimates of future new sales.

14. The computer-implemented method of claim 1, further comprising: estimating, based on historical account performance data, future cash flow and payouts net of deductibles.

15. The computer-implemented method of claim 1, further comprising: detecting potential fraudulent activity by comparing, using the machine learning model, performance data of new merchants to historical merchant performance data.

16. The computer-implemented method of claim 1, wherein dynamically adjusting the subscription's terms, billing cycle, and pricing comprises: pre-emptively reducing a customer's subscription value based on the artificial intelligence driven analysis to mitigate cancellations or chargebacks.

17. The computer-implemented method of claim 16, wherein the pre-emptive reduction in the customer's subscription value is performed on a recurring basis in compliance with the subscription terms.

18. The computer-implemented method of claim 11, further comprising: providing, via the user interface, real-time analytics and customer segmentation data to facilitate dynamic subscription management.

19. The computer-implemented method of claim 11, wherein routing the subscription transaction to the predicted optimal payment processor comprises: selecting, based on the machine learning analysis of real-time transaction data, the payment processor most likely to approve the subscription transaction.

20. The computer-implemented method of claim 11, further comprising: pre-authorizing a customer's payment method, forecasting potential chargebacks, estimating future cash flow, detecting potential fraudulent activity, and providing real-time analytics and customer segmentation data in an integrated system to proactively manage subscriptions and associated financial and fraud risks.
